(19) United States
(12) Patent Application Publication
(10) Pub. No.: US 2010/0250376 A1
(43) Pub. Date: Sep. 30, 2010

(54) VIRTUAL TERMINAL FOR MOBILE DEVICES

(76) Inventor: Srikanth Nandiraju, Santa Clara, CA (US)

Correspondence Address: Haynes and Boone, LLP;IP Section, 2323 Victory Avenue, SUITE 700, Dallas, TX, 75219, US

(21) Appl. No.: 12/415,663

(22) Filed: Mar. 31, 2009

(51) Int. Cl. G06Q 20/00; G06Q 30/00; G06Q 10/00

(52) U.S. Cl. 705/17; 705/21; 705/26; 705/34

(57) ABSTRACT

Systems and methods are disclosed herein to allow merchants having accounts with payment service providers to accept credit card payments using their mobile devices such as a cell phone, a PDA (Personal Digital Assistant) etc. A payment acceptance application running on the mobile device allows a merchant to enter the purchaser's credit card information and other billing information, to preview the information, to transmit the information to a remote website processing the payment, and to receive confirmation that the transaction has completed successfully.

### TECHNICAL FIELD

The present disclosure relates generally to online payment transactions. In particular, the present disclosure relates to a payment acceptance application for accepting credit card payments for online transactions using mobile devices.

### BACKGROUND

Online payment transactions have greatly facilitated the purchases of goods or services made over the Internet. For merchants, the ability to accept credit card payments online offers the assurance that payments will be made for the goods or services provided. The purchaser's credit card account may be verified for its validity and for sufficiency of funds, and the amount of purchase transferred from the credit card account to the merchant's account receivable. For purchasers alike, the ability to use credit cards for online payments offers unparalleled convenience. However, a merchant's ability to accept credit card payments often depends on the availability of credit card processing terminals. For a merchant traveling or visiting clients, the merchant may not have ready access to the use of credit card processing terminals, thus preventing the parties from consummating the payment transaction. Therefore, it is desirable for merchants to have the ability to accept credit card payments from anywhere and at anytime.

### BRIEF SUMMARY

Systems and methods are disclosed herein to allow merchants having accounts with payment service providers to accept credit card payments using their mobile devices such as a cell phone, a PDA (Personal Digital Assistant) etc. A payment acceptance application running on the mobile device allows a merchant to enter the purchaser's billing and order information including credit card information, to preview the information, to transmit the information to a remote website for payment processing, and to receive a confirmation that the transaction has completed successfully.

In accordance with one or more embodiments of the present disclosure, a payment acceptance apparatus includes a processor of a mobile device, and a memory that stores instructions for execution by the processor of the mobile device to provide a payment acceptance application for accepting credit card payments on the mobile device.

In accordance with one or more embodiments of the present disclosure, a method for accepting credit card payments using a mobile device includes displaying fields for entering order and billing information, accepting entries for the fields, transmitting the order and billing information to a remote website for payment processing, and receiving a confirmation of successful payment processing.

In accordance with one or more embodiments of the present disclosure, a computer program in a mobile device that includes a computer readable medium having instruction code for execution by a processor to perform a method, where the method includes displaying fields for entering order and billing information, accepting entries for the fields, transmitting the order and billing information to a remote website for payment processing, and receiving a confirmation of successful payment processing.

These and other embodiments of the present disclosure will be more fully understood by reference to the following detailed description of the embodiments when considered in conjunction with the accompanying drawings.

### BRIEF DESCRIPTION OF THE DRAWINGS

FIG. 1 shows a top level block diagram of a Virtual Terminal application running on a mobile device and interfacing with a remote payment processing application to accept and process credit card payments according to one or more embodiments of the present disclosure;

FIG. 2 shows a transaction process using a Virtual Terminal application running on a mobile device according to one or more embodiments of the present invention;

FIG. 3 shows a sample screen display of a billing information tab from running a Virtual Terminal application according to one or more embodiments of the present disclosure;

FIG. 4 shows a sample screen display of an optional information tab from running a Virtual Terminal application according to one or more embodiments of the present disclosure;

FIG. 5 shows a sample screen display of a preview tab from running a Virtual Terminal application according to one or more embodiments of the present disclosure;

FIG. 6 shows a sample screen display of a send tab from running a Virtual Terminal application according to one or more embodiments of the present disclosure;

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed to allow users who are subscribers of payment services to accept credit card payments using mobile devices without the use of credit card processing terminals. The mobile devices may be cell phones such as an iphone, a Google Phone, a Window Mobile, or PDAs with access to the Internet. The payment services may be provided by payment service providers such as PayPal Inc. of San Jose, Calif. Subscribers of the payment services may be merchants who have established accounts with the payment service provider to process credit card payments. For example, embodiments of the present disclosure allow a merchant on the go to use a mobile device running a payment acceptance application to access the merchant's PayPal account through the Internet. The merchant may enter a buyer's credit card information for payment processing by PayPal and to have PayPal transfer the payment amount from the buyer's credit card account into the merchant's PayPal account. The systems and methods disclosed may be extended to buyers who are subscribers of the payment service to make credit card payments using mobile devices. Thus, a buyer with a PayPal account may use the mobile device to make a purchase using a credit card and to have PayPal transfer the purchase amount from the credit card into the buyer's PayPal account so that the payment may be made to the merchant.

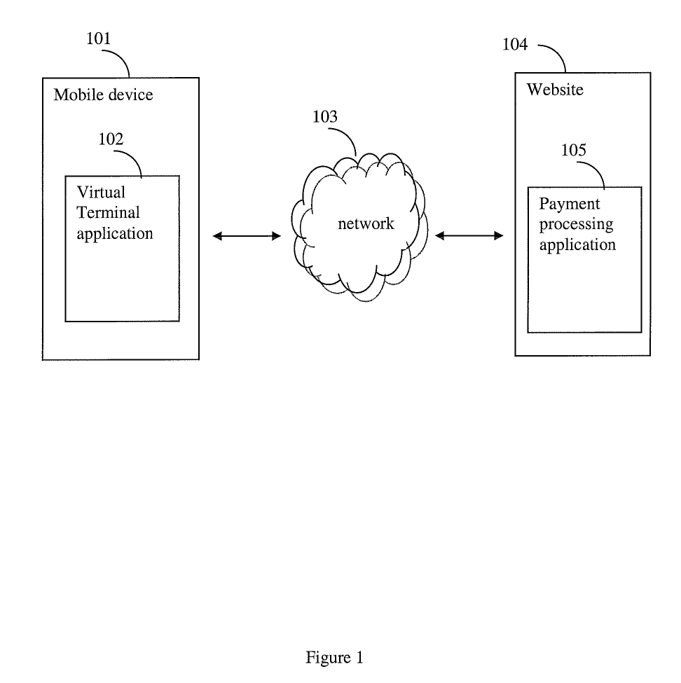

FIG. 1 shows a top level block diagram of a payment acceptance application running on a mobile device and interfacing with a remote payment processing application to accept and process credit card payments according to one or more embodiments of the present disclosure. In FIG. 1, the payment acceptance application is shown as a Virtual Terminal application 102 from PayPal running on a mobile device 101. However, the present disclosure may be embodied in other types of payment acceptance applications. The Virtual Terminal application 102 provides a user interface for the user to log into the user's PayPal account and to enter order and billing information related to the purchase such as a buyer's credit card number for processing. The Virtual Terminal application 102 also allows the user to view the status of payment processing. In addition, the Virtual Terminal application 102 may run a preliminary validation of the entered information. Such a preliminary validation may include validating that all the required information for payment processing has been entered or that the credit card number entered has the right number of digits. A payment processing application 105 running on a remote website 104 processes payment information received from the Virtual Terminal application 102 through PayPal.

Information entered through the Virtual Terminal application 102 is transmitted from the mobile device 101 through a network 103 to the remote website 104, which may be a server running the payment processing application. Status information is also transmitted from the website 104 back to the mobile device 101. The network may be the Internet or other type of communication network through which the mobile device 101 communicates with the website 104. The interface between the mobile device and the website 104 may be through PayPal's API (Application Programmers Interface) or other suitable interface to ease application development. For example, using a suitable API, the Virtual Terminal application 102 may invoke low level functions in the payment processing application 105 to request payment processing. The website 104 runs the payment processing application 105 to process payment information such as the credit card information of the buyer. The payment processing application 105 verifies the credit card number and, if the verification is successful, transfers the requested payment amount from the credit card to the user's PayPal account. After the payment transaction is successfully completed, the payment processing application 105 sends a confirmation back to the Virtual Terminal application 102. Otherwise, the payment processing application sends status information back to the Virtual Terminal application 102 to inform the user that the payment transaction fails to complete.

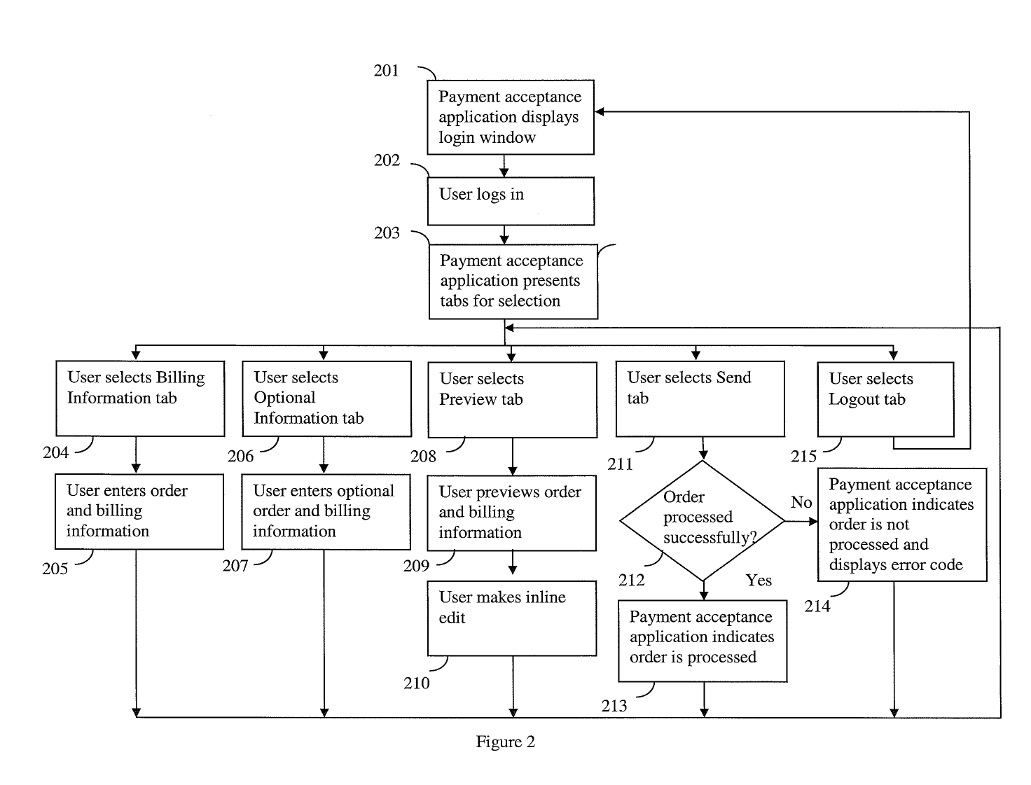

FIG. 2 shows a transaction process using a payment acceptance application running on a mobile device according to one or more embodiments of the present invention. In 201, the payment acceptance application displays a login window for a user to log into the user's payment service account. In 202, a user, such as a merchant with an account from the payment service provider, logs into the merchant's account using the merchant's account name and password. The login information is transmitted to the remote website running the payment service provider's payment processing application. The payment processing application authenticates the user and authorizes the payment acceptance application to display a menu of tabs for the user to select in 203. Alternatively, the menu of tabs may be a menu of buttons or other types of graphical user interface icon for the user to select. The menu of tabs, buttons, or icons is organized so that each tab, button, or icon may be selected to capture a specific category of information or to invoke a specific action related to the transaction process. For example, the menu of tabs may include a billing information tab, an optional information tab, a preview tab, a send tab, and a logout tab.

The billing information tab allows the payment acceptance application to capture order and billing information for the transaction. The optional information tab may be used to capture additional information for the transaction that may not be required but is useful to have. The preview tab presents the information captured from the billing information tab and the optional information tab to the user for final verification and editing before the information is transmitted to the payment processing application. The send tab transmits the entered information to the payment processing application for payment processing. Finally, the logout tab allows the user to log out from the user's payment service account.

In 204, the user may select the billing information tab to enter basic information for the purchase. The billing information tab captures and displays detailed order information and payment information for the purchase. The information may be further grouped by relevancy for ease of presentation and navigation. For example, information pertaining to the purchase amount may be grouped together under an order details category. Under the order details category, there may be fields for entering the order amount, for selecting the type of currency used to make the purchase, the region or zip code of the purchaser, the shipping method, and the transaction type. Based on the information entered, the order details category may display the rate of sales tax, calculate the sales tax, the shipping charge, and the total purchase amount. Similarly, information for the credit card may be grouped under the payment information category. Under the payment information category there may be fields for selecting the credit card type, for entering the credit card number, the expiration date, and other credit card information. In 205, the user interacts with the payment acceptance application to enter order and billing information into the billing information tab.

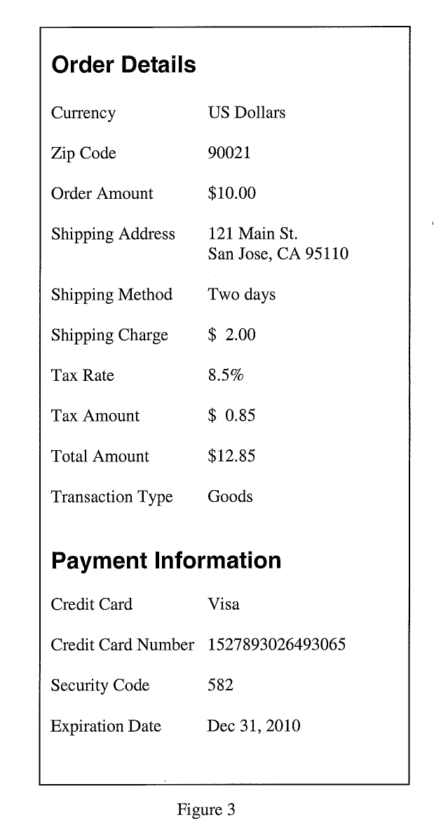

FIG. 3 shows a sample screen display of a billing information tab from running a Virtual Terminal application according to one or more embodiments of the present disclosure. Under the order details category, there are fields for the currency, zip code, order amount, shipping address, shipping method, shipping charge, tax rate, tax amount, total amount, and transaction type. Under the payment information category, there are fields for the credit card type, card number, security code, and expiration date.

To simplify user interface, the payment acceptance application may calculate and populate certain field entries based on the information that has been entered. The information in these populated fields is for display only and is not amenable to direct editing by the user. For example, the payment acceptance application may populate the tax rate field based on the tax jurisdiction of the purchaser. The payment acceptance application may also query for additional entries based on the type of information previously entered. For example, the payment acceptance application may query for the proper tax jurisdiction from the user only if the transaction is taxable, such as when the user has specified that the transaction is for the purchase of goods.

In one embodiment of the current disclosure, the user may initially select the currency field under the order details category. The currency field may display a pop-up submenu presenting the currency available for making the purchase. The user may proceed to select a currency. Based on the selected currency, the payment acceptance application may determine the country or the region from which the purchase originates. To determine the tax jurisdiction and the sales tax rate, the payment acceptance application may require additional information. For example, the billing information tab may present a field under the order details category for the user to enter a sub-region designation or a zip code within the originating region or country. Based on the originating country or region, along with the sub-region or zip code information, the payment acceptance application may determine the proper tax jurisdiction. From the tax jurisdiction, the payment acceptance application may determine the sales tax rate and populate the tax rate field with the correct tax rate.

The order details category may also present a transaction type field for the user to select the type of transaction for which payment is made. For example, the transaction may be a payment for the purchase of goods, potentially subjecting the purchase to sales tax in the tax jurisdiction from which the purchase originates. Alternatively, the transaction may be a payment for services rendered, in which case there may not be any tax levied against the transaction. The transaction may also be payments for a combination of goods and services, in which case the user may be prompted when entering the order amount to further break down the order amount into an amount for goods purchased and an amount for service rendered.

The user may then proceed to select the order amount field to enter the order amount for the purchase in the selected currency. From the order amount, the tax rate displayed in the tax rate field, and the transaction type, the payment acceptance application may calculate and display the sales tax in the tax amount field. To calculate any shipping charge, the billing information tab may also display a field for the user to enter the shipping address. After the user enters the shipping address, a shipping method field may be presented showing the available shipping methods and the associated shipping charge. The user may proceed to select the desired shipping method. The billing information tab may then display the shipping charge for the selected shipping method in the shipping charge field. To calculate the total amount, the payment acceptance application may add the order amount, the tax amount, and the shipping charge for displaying the total amount in the total amount field.

Under the payment information category, the billing information tab may present fields for the user to enter information on the credit card to be used for the purchase. For example, there may be a field for the user to select the type of credit card, a field to enter the credit card number, a field for the security code, and a field for the expiration date. As the user enters the credit card information, the payment acceptance application may run an initial validation of the entered information and, if the information is determined to be invalid, prompt the user to make corrections. For example, the payment acceptance application may validate the credit card by determining if the credit card number has the right number of digits or if the expiration date is a future date. If the credit card number does not have the right number of digits, or if the expiration date is a date in the past, the user is alerted and prompted to enter the correct information. Thus, the initial validation step detects obvious errors so that the user may correct the information right away without having to wait for the payment processing application to reject the credit card information when it tries to authenticate the credit card information later on.

Referring back to FIG. 2, in addition to the information captured in the billing information tab, the payment acceptance application may present an optional information tab to capture and display optional information for the order. The payment processing application may use the optional information to track the order, to better identify the purchaser, or may use the information to generate an order history report for the account holder. In 206, the user may select the optional information tab. Similar to the billing information tab, the optional information tab may group optional information by relevancy into categories for ease of presentation and navigation. For example, there may be a category for optional order details, a category for optional credit card information, and a category for the address of the purchaser. In 207, the user interacts with the optional information tab to enter optional information into the payment acceptance application.

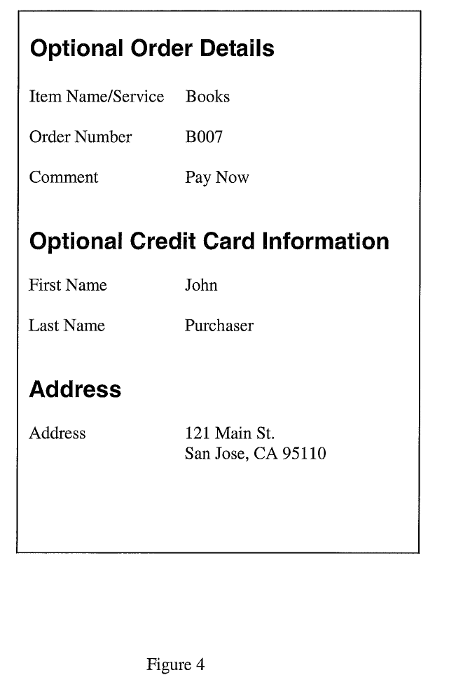

FIG. 4 shows a sample screen display of an optional information tab from running a Virtual Terminal application according to one or more embodiments of the present disclosure. In one or more embodiment of the current disclosure, under the optional order details category, there may be an item name/service field for the user to enter information about the item or service purchased. Alternatively, the user may select from a menu listing of all items or services offered to enter the information. The payment acceptance application may assign and display an order number in an order number field based on the entry in the name/service field. There may also be a comment field for the user to enter additional information on the order. The information from the optional order details category may enable tracking of the order based on the item/service purchased or the order number assigned. Under the optional credit card information category, the user may enter the name of the credit card holder in a first name and a last name field. Finally, under the address category, the user may enter the address of the purchaser. Information from the optional credit card information category and the address category may enable tracking of the order based on the name or the address of the purchaser.

Referring back to FIG. 2, after the user enters the information in the billing information tab and optionally in the optional information tab, the user may select the preview tab 208 to verify and edit the order and billing information before transmitting the information to the payment processing application for processing. The preview tab displays the order and billing information from fields in the billing information tab and the optional information tab. In 209, the user previews the information. The preview tab may provide an inline editing feature to allow the user to make changes to the field entries from within the preview tab. The user may select the field and make any desired changes 210. Any edits to the field entries in the preview tab are also reflected in the corresponding field entries in the billing formation tab or the optional information tab. In addition, edits made to a field entry may also update entries in related fields. For example, edits to the order amount may update the sales tax and the total amount displayed in the tax amount and total amount fields respectively. The editing features of the preview tab also give users the choice to bypass the billing information tab or the optional information tab altogether and to enter order and billing information directly into the preview tab. However, user interface in the billing information tab and the optional information tab may be simpler than that in the preview tab since there are fewer fields to navigate.

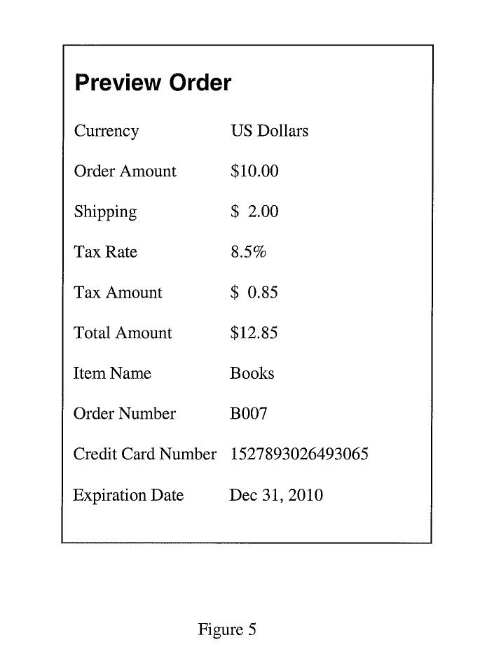

FIG. 5 shows a sample screen display of a preview tab from running a Virtual Terminal application according to one or more embodiments of the present disclosure. The currency, order amount, shipping, tax rate, tax amount, and total amount fields display information from the order details category of the billing information tab. The item name and order number fields display information from the optional order details category of the optional information tab. The credit card number and the expiration date fields display information from the payment information category of the billing information tab. The user may select certain fields such as the order amount field to perform inline editing. Edits to the order amount field may also cause the payment acceptance application to update the shipping, tax amount, and the total amount fields in the preview order as well as their corresponding field entries in the billing information tab.

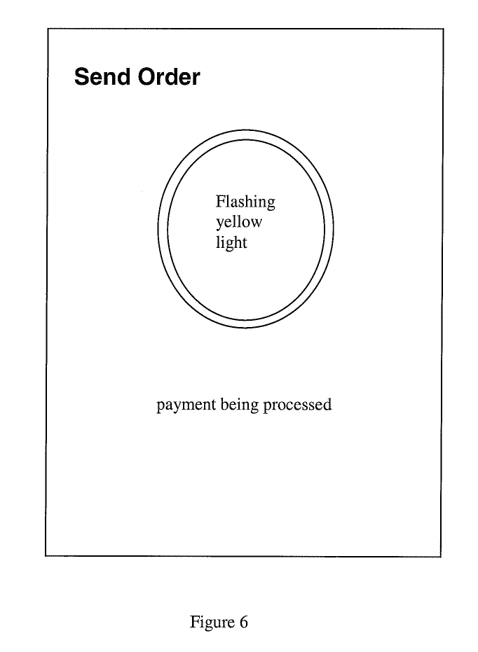

Referring back to FIG. 2, when the user has verified the order and billing information in the preview tab and is ready to place the order, the user may select the send tab 211. The payment acceptance application then transmits the information in the preview tab to the payment processing application on the remote website for payment processing. The transmitted information may be encrypted using SSL for security. To aid the user, the send tab may display a visual indication of the status of the processing. For example, the send tab may display a flashing yellow light when the payment is being processed. FIG. 6 shows a sample screen display of a send tab from running a Virtual Terminal application showing the flashing yellow light according to one or more embodiments of the present disclosure

The payment processing application processes the payment by verifying the validity of the credit card number and requesting that the total amount charged be debited from the credit card and transferred into the user's account with the payment service provider. Referring back to FIG. 2, if the payment is successfully processed in 212, the payment processing application may transmit a confirmation signal back to the payment acceptance application. The send tab may then turn the flashing yellow light to a solid green to indicate to the user that the order has been successfully processed 213. Otherwise, if the payment cannot be processed, the payment processing application may transmit an error code to the payment acceptance application to indicate the type of processing error. Upon receiving the error code, the send tab may turn the flashing yellow light to a solid red to indicate that the payment processing has failed and may also display an error message corresponding to the received error code in 214. The error message alerts the user to the type of error, such as an invalid credit card number, so that the user may go back to the preview tab to correct the error for retransmission and payment reprocessing.

Once the payment has been successfully processed or if the user wants to exit the payment acceptance application, the user may select the logout tab 215 to terminate the transaction process. The mobile device then displays the login window for the next session.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as program code and/or data for the payment acceptance application, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, payment with a credit card is described; however other payment mechanisms may also be suitable for use, such as a debit or bank card. In addition, although PayPal is used as the payment service provider in the descriptions, any suitable on-line payment provider or financial services provider may be used to process payments from the mobile device. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

We claim:

1. A payment acceptance apparatus comprising:
a processor on a mobile device; and
a memory adapted to store a plurality of machine-readable instructions for the mobile device wherein the memory is executed by the processor to provide:
a payment acceptance application adapted to accept a financial card payment on the mobile device.

2. The payment acceptance apparatus of claim 1, wherein the payment acceptance application comprises a login window adapted to restrict access to the payment acceptance application to a subscriber of a payment service provider.

3. The payment acceptance apparatus of claim 2, wherein the payment acceptance application is further adapted to communicate with a remote payment processing application to authenticate the subscriber of the payment service provider.

4. The payment acceptance apparatus of claim 1, wherein the payment acceptance application is further adapted to receive card information and detect the card information for errors.

5. The payment acceptance apparatus of claim 2, wherein the payment acceptance application further comprises an optional information tab adapted to accept and display optional order and billing information from the subscriber of the payment service provider.

6. The payment acceptance apparatus of claim 2, wherein the payment acceptance application further comprises a preview tab adapted to display order and billing information for verification.

7. The payment acceptance apparatus of claim 6, wherein the payment acceptance application is further adapted to accept and display in-line editing of information in the preview tab.

8. The payment acceptance apparatus of claim 2, wherein the payment acceptance application further comprises a send tab adapted to transmit order and billing information to a remote payment processing application for payment processing.

9. The payment acceptance apparatus of claim 8, wherein the send tab is further adapted to display a visual indication of a status of the payment processing.

10. The payment acceptance apparatus of claim 8, wherein the payment acceptance application is further adapted to receive a confirmation from the remote payment processing application when the payment processing is successfully completed.

11. The payment acceptance apparatus of claim 8, wherein the payment acceptance application is further adapted to receive an error code from the remote payment processing application for display of an error message when the payment processing is not successfully completed.

12. The payment acceptance apparatus of claim 2, wherein the payment acceptance application further comprises a logout tab adapted to terminate access to the payment acceptance application.

13. The payment acceptance apparatus of claim 2, wherein the payment acceptance application is further adapted to communicate with a remote payment processing application to process the financial card payment.

14. The payment acceptance apparatus of claim 1, wherein the financial card is a credit card.

15. A method of accepting a credit card payment on a mobile device, comprising:
displaying fields for entering order and billing information;
accepting entries for the fields;
transmitting said order and billing information for payment processing; and
receiving confirmation of successful payment processing.

16. The method of claim 15, further comprising restricting access for entering said order and billing information to a subscriber of a payment service provider.

17. The method of claim 15, further comprising detecting said billing information for errors.

18. The method of claim 15, further comprising:
displaying said order and billing information for confirmation; and
allowing in-line editing of said order and billing information before transmitting for payment processing.

19. The method of claim 15, further comprising displaying a visual indication of a status of said payment processing.

20. The method of claim 15, further comprising:
receiving an error code when said payment processing is not successful; and
displaying an error message.

21. The method of claim 15, wherein the billing information is for a credit card.

22. A computer program product in a mobile device comprising a computer readable medium having computer readable code for instructing a processor to perform a method, the method comprising:
displaying fields for entering order and billing information;
accepting entries for the fields;
transmitting said order and billing information for payment processing; and
receiving confirmation of successful payment processing.
